(19) United States
(12) Patent Application Publication
(10) Pub. No.: US 2001/0010659 A1
(43) Pub. Date: Aug. 2, 2001

(54) MIXING DEVICE

(76) Inventors: KJELL FORSLUND, SUNDSBRUK (SE); MAGNUS DANIELSSON, SUNDSVALL (SE); TOMAS WIKSTROM, SUNDSVALL (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/202,760

(22) PCT Filed: May 29, 1997
(86) PCT No.: PCT/SE97/00918

§ 371 Date: None

(30) Foreign Application Priority Data
Jun. 26, 1996 (SE) 9602543-2

(51) Int. Cl. B01F 15/00

(52) U.S. Cl. 366/167.1; 261/76

(57) ABSTRACT

A device for admixing an agent in the form of gas or liquid to a material flow. The device comprises a chamber (1) with an inlet (3) and an outlet (4) for connection to ingoing and, respectively, outgoing line (7, 8) for throughflow of the agent, and means (12, 19, 20) for the supply of agent to the chamber (1). The chamber (1) is defined by a cylindric jacket (2) where the inlet (3) and, respectively, outlet (4) is provided with flanges (5, 6, 18, 21), and where the inlet flange (5, 18, 21) has a smaller diameter than the ingoing line (7). Means (12, 19, 20) for the supply of agent are located in the jacket (2) of the chamber (1).

This invention relates to a device for admixing an agent in the form of gas or liquid to a material flow. The device comprises a chamber, through which the material flow is intended to pass, and means for the supply of gas/liquid to the chamber. The device is intended especially for admixing a gas, such as steam or bleach gas, to a pulp suspension.

At the treatment of pulp suspensions, various processing agents are to be admixed, for example for heating or bleaching purposes. It is desired in this connection to atomize the agent in the pulp while the pulp is being transported. For heating the pulp, steam is supplied, which condenses and thereby delivers its heat content to the pulp. At bleaching, bleaching agent is added to react with the pulp. In connection with the treatment of recycled fiber pulp, black ink is separated by flotation, implying that air is to be atomized in the pulp.

In all these cases it is difficult to achieve uniform admixing. At the heating of pulp by steam supply to a pulp line, problems often are caused by the formation of large steam bubbles on the inside of the line. When these bubbles rapidly condense, they give rise to condensate bangs, which cause detrimental cavitations in the line and subsequent equipment. It is also difficult to achieve an entirely uniform temperature profile in the pulp. This can be cured by inserting steam supply lines into the pulp line, but this deteriorates the flow in the line.

For a more uniform admixture of the agent, the material flow can be divided into narrow gaps where the processing agent is supplied. This, however, restricts the capacity and implies a greater risk of clogging. Problems also arise when the material after its passage through the gaps again is united to one flow.

The present invention has the object to eliminate the aforesaid problems. According to the invention, the processing agent is supplied to a chamber with cylindric jacket, through which the material flow passes. The characterizing features of the invention are apparent from the attached claims.

The material flow passing through the chamber is supplied through an ingoing line and removed through an outgoing line. Due to the reduction in area from the ingoing line to the chamber, according to the invention a deformation of the flow field of the material flow takes place at the entrance to the chamber. The area reduction should be 10-90%, preferably 40-60%.This gives rise to shear stresses in the material which have a certain short duration. By utilizing this condition of the material for the admixture of the agent, a uniform mixing of atomized agent in the material is obtained.

The invention is described in greater detail in the following, with reference to the accompanying drawings illustrating some embodiments of the invention.

FIGS. 1-3 are sections through three embodiments of the device,

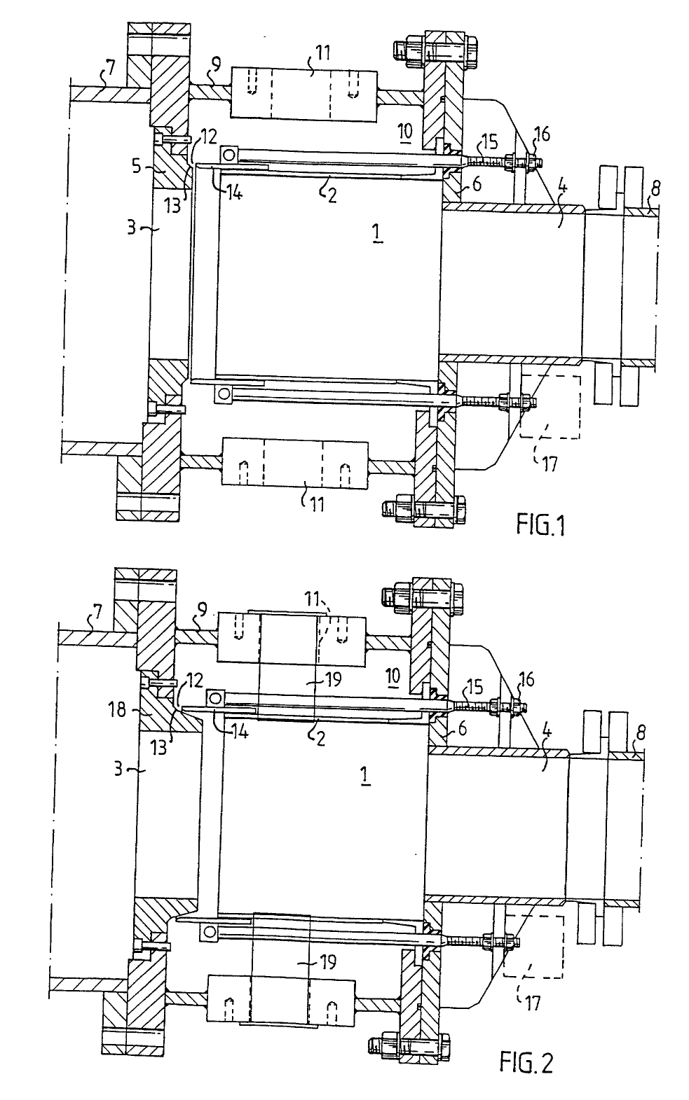

FIG. 4 is an end view according to FIG. 2.

The device according to FIG. 1 consists of a chamber 1, which is outwardly defined by a cylindric jacket 2.

The inlet 3 and, respectively, outlet 4 of the chamber 1 are provided with flanges 5,6. The diameters of the openings in the flanges 5,6 are smaller than that of the chamber 1. The inlet flange 5 preferably is exchangeable to permit change of the inlet diameter. The opening of the outlet flange 6 should be equal to or smaller than the opening of the inlet flange 5.

The device is connected to an ingoing line 7 for the material flow, to which the agent shall be admixed. The inlet flange 5 has a diameter smaller than the diameter of the ingoing line 7. The outlet 4 of the chamber 1 is connected to an outgoing line 8 for the material flow with admixed agent.

The jacket 2 of the chamber 1 is enclosed in a housing 9 whereby an overall space 10 for atomizing the agent is formed between the jacket 2 and housing 9. The agent is supplied to the space 10 through connections 11, preferably several ones distributed about the housing 9. The lowest located connection 11 can be used alternatively for condensate and draining. The space 10 communicates with the chamber 1 via an overall adjustable gap 12, through which the agent is supplied. Said gap 12 is defined by a seat 13 on the inlet flange 5 and an axially movable ring 14. Said ring 14 is guided on the jacket 2 and via set screws 15 can be adjusted by nuts 16 or setting means 17 for adjusting the gap 12. By using setting means 17, the setting of the gap can be coupled to the control of the agent supply. The gap can thereby be closed at the same time as the agent supply is cut off, so that the material does not penetrate out into the space 10.

By the reduction in area from the ingoing line 7 to the inlet flange 5, the condition in the material flow favourable for the admixing, as described above, is obtained. The effect is increased additionally at the outlet 4, because the area reduction from the chamber 1 to the outlet flange 6 causes the same phenomenon.

The embodiment shown in FIG. 2 corresponds substantially to that shown in FIG. 1. The inlet flange 18, however, is modified so as to extend into the chamber 1, and the gap 12 is located outside the inlet flange 18. This implies, that an ejector effect for ingoing agent is obtained, which can still more promote uniform admixing.

Two insert pipes 19 for agent supply are connected to the jacket 2 of the chamber 1. By this arrangement, a still more effective penetration of the agent into the material flow is obtained. It can be advantageous to use this embodiment especially at steam supply for heating the material. This applies especially when the desired increase in temperature is great, 20-25° C.

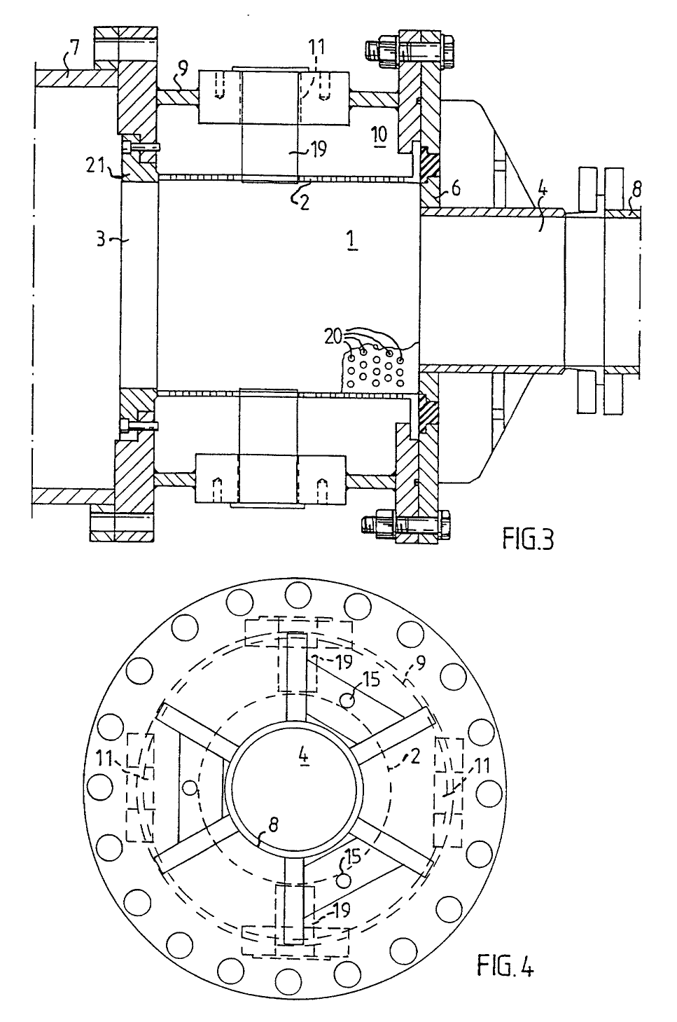

A further embodiment is shown in FIG. 3 where the jacket 2 of the chamber 1 is provided with perforations 20 for the supply of agent. These perforations replace the gap in the aforesaid embodiments. The diameter of the opening in the inlet flange 21 is here equal to that of the chamber, while the diameter of the opening in the outlet flange 6 is smaller than that of the chamber as shown in earlier embodiments. As at the embodiment according to FIG. 2, insert pipes 19 are inserted through the jacket 2 of the chamber to improve the penetration of the agent.

The invention, of course, is not restricted to the embodiments shown, but can be varied within the scope of the invention idea.

1. A device for admixing an agent in the form of gas or liquid to a flow of material, for instance a pulp suspension, comprising a chamber (1) with an inlet (3) and an outlet (4) for connection to ingoing and, respectively, outgoing line (7,8) for throughflow of the material, and means (12,19,20) for the supply of the agent to the chamber, characterized in that the chamber (1) is defined by a cylindric jacket (2), that the inlet (3) and, respectively, outlet (4) is provided with flanges (5,6,18,21) where the opening in the inlet flange (5,18,21) has a smaller diameter than the ingoing line (7), and that the means (12,19,20) for the supply of the agent are located in the jacket (2) of the chamber (1).

2. A device as defined in claim 1, characterized in that the opening in inlet flange (5,18) has a diameter smaller than the diameter of the chamber (1).

3. A device as defined in claim 2, characterized in that an overall adjustable gap (12) is formed in the jacket (2) of the chamber (1) for controlled supply of the agent.

4. A device as defined in claim 3, characterized in that the gap (12) is located at the inlet (3) to the chamber (1).

5. A device as defined in claim 4, characterized in that the inlet flange (18) extends into the chamber (1), and the gap (12) is located radially outside the extended inlet flange (18), so that ejector effect for ingoing agent is obtained.

6. A device as defined in claim 1, characterized in that the jacket (2) of the chamber (1) is formed with perforations (20) for the supply of agent.

7. A device as defined in claim 1, characterized in that at least two insert pipes (19) are inserted through the jacket (2) of the chamber (1) for the supply of agent.

8. A device as defined in claim 1, characterized in that the jacket (2) of the chamber (1) is enclosed in a housing (9), and an overall space (10) between the jacket (2) and housing (9) constitutes a distributor for the agent about the chamber (1).
